(19) United States
(12) Patent Application Publication
(10) Pub. No.: US 2004/0069631 A1
(43) Pub. Date: Apr. 15, 2004

(54) Method and device for carrying out 2d electrophoresis in large gels

(76) Inventor: Joachim Klose, Berlin (DE)

Correspondence Address: HARNESS, DICKEY & PIERCE, P.L.C., P.O. BOX 8910, RESTON, VA, 20195, US

(21) Appl. No.: 10/398,408

(22) PCT Filed: Oct. 4, 2001
(86) PCT No.: PCT/DE01/03869

(30) Foreign Application Priority Data
Oct. 5, 2000 (DE) 100 50 838.3

(51) Int. Cl. G01L 1/20

(52) U.S. Cl. 204/450; 204/600

(57) ABSTRACT

A method and apparatus for separating and identifying proteins in protein mixtures using a protein-permeable material in the shape of a tube, hose, capillary, fiber, or braided tubes or fibers. Proteins are separated in a first dimension, then the porous protein-permeable material is inserted into a case containing a flat gel without removing the gel fiber from the porous tube. Separation in a second dimension is then performed by gel electrophoresis. The porous protein-permeable material may be encased in a plastic housing which may connect several porous tubes and form a tube array. The tube array may be enclosed and connected by a double-layer plastic film, which can be easily separated to remove the porous tubes. A transverse reinforcement platform and a clamping member may fasten the tube array in an isoelectric focusing chamber. A pipetting robot may be provided for automatically dispensing a protein sample into the porous tube.

The invention relates to a method and a device for the separation of complex protein mixtures with the help of high-resolution two-dimensional electrophoresis (2D electrophoresis, 2DE) in large gels. The 2DE forms together with the mass spectrometry the basic technology e.g. for the “proteom analysis”, i.e. for the separation and identification of the overall protein of a cell type, organ, or organism.

The high-resolution two-dimensional electrophoresis (2-DE) is a proven method for the separation of protein mixtures (patents: U.S. Pat. No. 5,837,116—California Inst. of Technology, US, 1999; Bio-Rad Lab. Inc., US, 1998; U.S. Pat. No. 5,773,645, EP 877245 and 1990: U.S. Pat. No. 4,874,490, EP 366897; DE 4244082—ECT GmbH, DE, 1994; JP 05048421, U.S. Pat. No. 4,866,581—Hitachi Ltd., JP, 1986; Aimes, G. F., Nikaido, K.: PubMed Abstract: Biochemistry, 1976, Vol. 15, No. 3, p. 616-623; U.S. Pat. No. 5,534,121), which are extracted from organic tissue. Currently, and in particular after completion of the human genome project, this method is gaining importance in research and the pharmaceutical industry as a key method of the post-genome era. However, the implementation of the 2DE is still widely done manually. The success depends very much on the skill of the person applying the method.

2-DE in its high-resolution form was published in 1975 by J. Klose [1-bibliography] and P. O'Farrell [2] simultaneously and independent from each other. In the 80s the method was modified with regard to one essential technical detail [3-5] by LKB, today known as Pharmacia: The carrier ampholytes (Carrier Ampholyte, CA) migrating freely in the electric field were replaced by ampholytes that firmly bond to the gel matrix (immobilized pH-gradients, IPG; Immobiline®). Accordingly, today the 2-DE is used in two versions: CA-2DE (Klose, O'Farrell) and IPG-2DE (Pharmacia).

The CA-2DE Method:

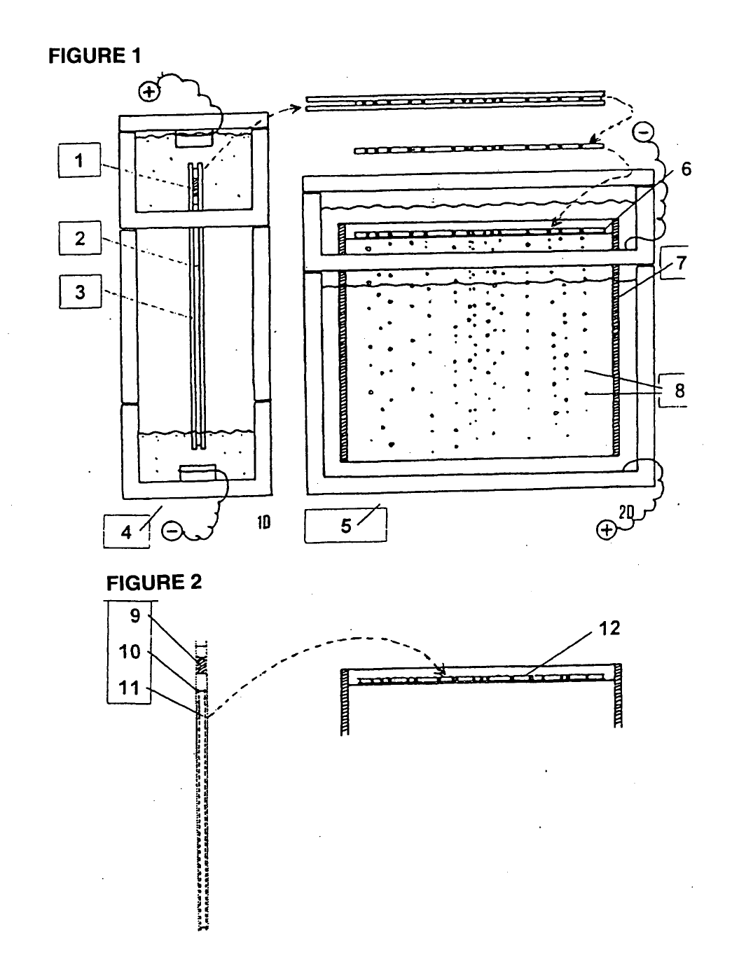

The protein mixture is applied onto a polyacrylamide gel, which is located in a glass capillary. The proteins are separated in the electric field according to the principle of isoelectric focusing: The freely moving ampholytes form under voltage a pH-gradient, on which, at the same time, the proteins arrange themselves according to their isoelectric spot. After the completed separation of the proteins in the first dimension (1D) the gel is ejected from the capillary tube. The gel is then present in the form of thin long gelatinous fibers. This gel fiber is picked up and placed in a rectangular glass case with a large surface, which again contains polyacrylamide (FIG. 1). The proteins migrate under electricity out of the gel fiber and are further separated in the thin, large-surface gel in the direction of the second dimension (2D) according to the principle of the SDS gel electrophoresis (SDS—sodium dodecylsulphate). The CA-2DE was further developed by Klose and Kobalz [8] into a so-called large gel technology some years ago: The 1D gel fiber is 41 cm long (diameter 0.9 mm), the 2D gel has the measurements 46 cm×30 cm; thickness 0.75 mm (the gel is produced in two halves). With this gel technique the highest possible resolution is reached today (more than 10,000 proteins per gel).

The IPG-2DE Method

In this method the ampholytes are chemically bound to the acrylamide (=gel matrix substance). Two solutions are produced, one with ampholytes for the low pH-level, and one for the high pH-level. Then with these two solutions a gel is poured with a gradient mixer, which contains the finished pH-gradient. These IPG gels (IPG—immobilized pH-gradients, Immobiline®) are not poured into capillary tubes, but in a flat gel. The gel is then dried and cut into strips. The strips are sold commercially. The user swells the strips in a buffer, applies the sample and thus carries out the 1D step. The separation in the 2^{nd} dimension takes place as in the CA method. The available gels are relatively small, i.e. at a maximum 23 cm×20 cm.

Comparison of CA- and IPG-Methods

CA-Method:

| | |
|---|---|
| Advantages: | High resolution due to large gels, clear separation, good reproducibility. |
| Disadvantages: | Largely manual execution, therefore complex and dependent on the skills of the |
| | user. |
| IPG-Method: | |
| Advantages: | The 1D gels (dried gel strips) are available ready-for-use. That means it is a |
| | significantly simpler method. In addition to that, very distinctive marketing efforts |
| | are performed by the companies Pharmacia and BioRad (manual, sales events, |
| | workshops). Therefore this method dominates the market today. It is practically |
| | used by all beginners. After expiration of the IPG patent (Swedish patent 14049-1) |
| | the number of manufacturers will increase. |
| Disadvantages: | Resolution and separation are comparatively bad because only relatively small gels |
| | (see above) can be used. The IPG technique was developed with the aim to |
| | considerably improve reproducibility through the bonding of the ampholytes to the |
| | gel matrix. However, the theoretically expected improvement is practically |
| | non-existent (cause: effect of the proteins on the pH-gradient and the like; see also |
| | IPG-2DE “product test” on the 7^{th} Workshop “Micro-methods in the Protein |
| | Chemistry”, MPI Martiensried, June 2000). |
| Remark: | The large gel technique developed by Klose is known in expert circles worldwide |
| | [lectures, publications, e.g. 7, 8]. Their high resolution and separation ability is |
| | commonly recognized. However, in practical terms the method is basically |
| | considered complicated. |

When performing the CA-2DE technique, the most difficult and elaborate steps are the pouring of the 1D gels into the capillaries, the ejection of the gel strip from the capillaries after the run and the transfer of the long gel fiber onto the 2D gel.

It is the object of the invention to develop a method and a device, which allows a considerable simplification of the separation of protein mixtures.

The task was solved as follows:

The separation of the proteins in the first dimension is performed in protein-permeable materials—porous, capillary tubes, which could also be hose-like. The porous capillary tube is then inserted into a glass case containing a flat gel, without having to eject the gel fiber and therefore having to transfer it as such. The proteins then migrate under the influence of electricity through the wall of the tube into the flat gel. Braided plastic fiber tubes and ceramic capillary tubes have been proven to be suitable tube types:

When using braided polyester tubes [12, 14, 15, 16] the 2D gels exhibited the expected protein spots based on a test sample. This finding clearly proves that the proteins can be focused normally in these gel tubes and that they are able to migrate through the tube wall into the 2D gel.

When using ceramic capillary tubes or ceramic hollow fibers [9, 10, 12] at first a gel solution was mixed with the test sample, and then the tubes were filled with this mixture. After polymerization and application of the tubes on the 2D gels, the SDS gel electrophoresis was performed as usual. The result showed that the proteins in the electric field migrate through the tube without difficulty. The test sample contained proteins with different molecular weights and isoelectric points. After their passing through the tube and after separation in the SDS gel, the protein bands appear, as hoped, according to the different molecular weights. This finding is insofar surprising that it does not comply with the general expectations and therefore was not tested before. General experience has shown that minimal disturbances (small air bubbles, impurities) in the electrophoretic track of the proteins interfere with the separation of the proteins.

Therefore it had to be assumed that the porous tube has a filtration effect on the migrating proteins, which hinders or impairs a clean merging of the protein molecules to individual protein spots. However, this effect did not occur. In fact, the desired protein spots were formed.

Therefore the gel fiber does not need to be ejected after isoelectric focusing, but the entire capillary tube can be placed in the glass case for further separation of the proteins. The proteins then migrate under the influence of electricity through the wall of the tube into the flat gel. After the electrophoresis of the proteins in the second dimension the capillary tube with the empty gel is discarded. The capillary tube with the ready-to-use gel (gel tube) is offered commercially. This way the pouring and ejection of the gels is eliminated, and the transfer of the 1D gel onto the 2D gel has become a simple task for the user. The raw material used pursuant to the invention is permeable to proteins up to a size of 400 kDa (FIG. 2). With the selection of the pore size certain molecular weight ranges can be given preferences, which enables an additional improvement in the resolution.

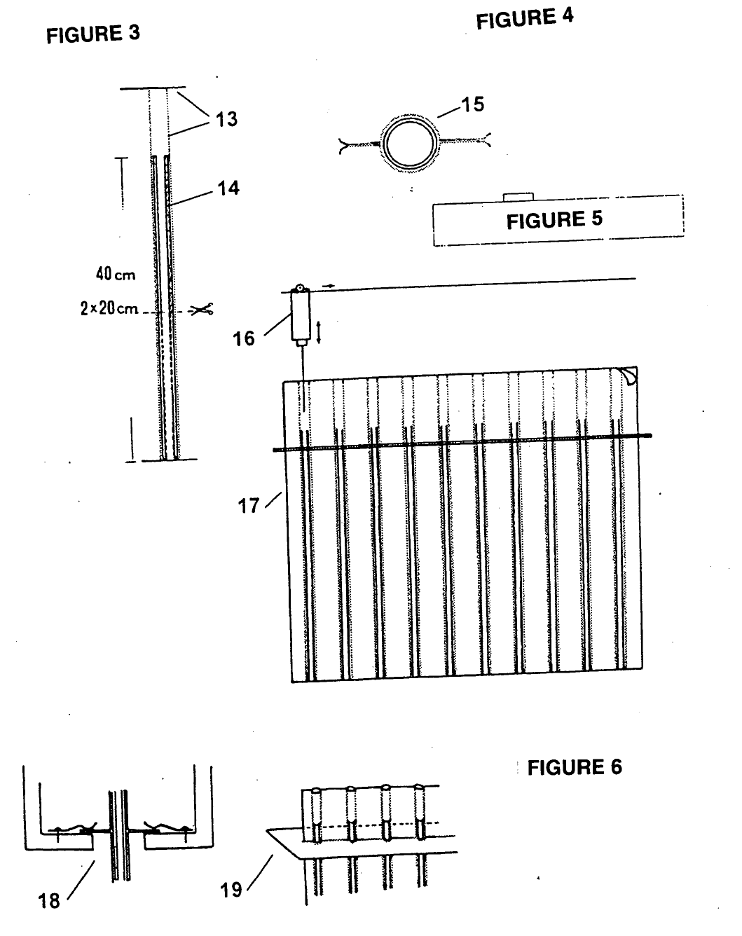

The invented device for separating complex protein mixtures with the help of high resolution two-dimensional electrophoresis (2-DE/2DE) consists—apart from standard elements for 1D as well as for 2DE techniques—of protein-permeable materials in the shape of porous tubes, e.g. a capillary tube or a capillary hose, particularly a plastic fiber braided tube or a ceramic capillary tube or hollow ceramic fibers, furthermore of a glass case containing a flat gel, of a gel tube, tube array and pipetting robot, tube array and buffer chamber, 2D cases, 2D cases in the buffer chamber, a special 1D chamber, 2D gels as finished gels, a 2D chamber, and possibly IPG gels in tubes as well as an HTP-2DE apparatus (high throughput technique). In detail the invented device consists initially of standard elements used for 1D as well as 2DE techniques (FIGS. 1 and 2) with the glass tube (3), the protein sample (1) in the IEF gel (2) in an isoelectric focusing device (4). The SDS gel electrophoresis device (5) in the gel case (7) contains the IEF gel on the SDS gel (6), which after the electrophoresis, during which the protein sample (9) in the porous gel tube (11, 12) is applied to the gel case (7) upon removal of the plastic casing (10), provides the protein spots (8). The porous capillary tubes (14) are enclosed (15) by a plastic casing (13), which connects several tubes (FIG. 3, cross-sectional view FIG. 4). The capillary tubes form the tube array (17), enclosed and connected by a double-layer plastic film. After tearing the two layers open, the tubes can be removed. A transverse reinforcement (platform) serves the fastening of the tube array in the focusing chamber. The tube array (17) is equipped with a pipetting robot (16) (FIG. 5). The tube array

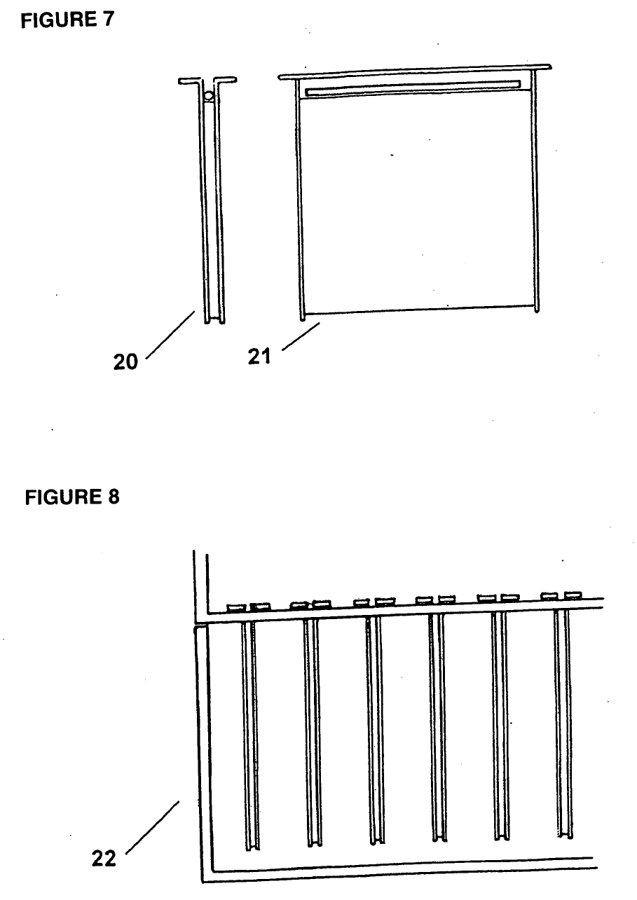

(FIG. 6) is attached in the focusing chamber by means of a clamping device (18). It forms a platform (19 top view). The invented 2D case (20 in cross-sectional view, 21 in side view, 22 in the buffer chamber in FIG. 8) contains the SDS gel and the IEF gel (FIG. 7).

The polymer membrane, which is used pursuant to the invention, in the form of hollow fibers (diameter up to 0.5 mm), capillaries (diameter up to about 3 mm) and tubes are offered commercially by various manufacturers: Fresenius GmbH, Gambro Dialysatoren GmbH & Co KG, Akzo Faser AG [14] or Reichelt Chemietechnik [11] in Germany, X-Flow B.V. in Holland, and AGT-A/G Technology Corporation in the USA [16] are such manufacturers. A very large market with millions of square meters is represented by artificial kidneys and plasma separators. The main components of these elements are capillary membranes with a defined pore structure.

The polysulphone tubes mentioned in Example 1 come from AGT in the U.S. The braided tubes mentioned in the examples are obtained from the Erfurt, Germany company Flechttechnik [15]. In the braided tubes made of full plastic fibers the pores are formed by the structure and configuration of the fibers.

Apart from the resins polyester (polycarbonates, polyalkylene terephthalates), polysulphones (polyether sulphones, polyarylether sulphones, polyaryl sulphones) or polyether ketones for membranes, it is also possible to use natural fibers (such as silk or cotton) or inorganic fibers (such as glass, ceramic and other oxide fibers) as well as non-oxide fibers for the braided tubes. Porous hollow fibers are described in Lück et al [13].

In the production of braided tubes, fibers made of polyalkylene terephthalates, particularly polyethylene terephthalate—have proven to be very useful apart from polybutylene terephthalate and poly(1,4-cyclohexane dimethylene)-terephthalate.

The gel tubes pursuant to the invention have pore sizes from 0.2 to 0.005 μm:

0.2 μm for proteins smaller than 400 kDa

0.1 μm for proteins smaller than 200 kDa

0.05 μm for proteins smaller than 100 kDa

0.03 μm for proteins smaller than 60 kDa

0.01 μm for proteins smaller than 20 kDa

0.005 μm for proteins smaller than 10 kDa

The features of the invention are revealed not only in the claims, but also in the description, wherein the individual features represent beneficial embodiments either alone or as several in the form of combinations, for which protection is sought with this document. The combination consists of familiar elements (1D as well as 2DE techniques, CA-2DE as well as IPG-2DE techniques) and new solution approaches (1-DE protein separation in hollow porous protein-permeable materials and their unmodified use in the second dimension, 2D gels as finished gels, HTP-2DE technique), which influence each other and in their new overall effect result in an advantage (synergistic effect) and the desired success, which consists of combining now simple handling with high and clean protein resolution.

The use of the new large gel technique pursuant to the invention consists of the break-down of complex protein mixtures. Furthermore the use pursuant to the invention relates to the use of the hollow porous materials in the form of hollow plastic fibers or plastic braided tubes, especially of polyester braided tubes or ceramic capillary tubes/ceramic hollow fibers in the 1D electrophoresis and then in the unmodified state in the 2D electrophoresis.

Since the development of the 2D electrophoresis approximately 25 years ago, isoelectric focusing, i.e. separation of the proteins in the first dimension, has been conducted in tubes, a little later than in flat gels, particularly in gel strips. The gel tubes were made of glass or plastic material, i.e. of water- and air-permeable material. There has never been a reason to produce these tubes from porous material since the gel would quickly dry out in such tubes and would come into contact with the electrode solution during the electrophoresis run. The latter would lead to the fact that the pH gradient would not be constructed and thus no focusing would take place. Focusing in porous tubes should therefore not be considered a logical, obvious modification of the tube technique.

It was only with the development of the invented large gel technology that a completely new idea was introduced. Since the gels in the invented glass tube have a length of more than 40 cm and a thickness of less than 1 mm, it is true that they provide an unusually high resolution, however practically they are very difficult to handle. These long, thin and soft gel fibers can hardly be pushed out of the tube without damaging them and can be applied onto the SDS gel—for the purpose of separation in the second dimension—only with a lot of skill and experience. Pursuant to the invention, this problem has been resolved with the development of a completely new type of gel tube:

1. The gels are poured into tubes, which have the same dimensions as the long, thin gel tubes; the wall of these tubes however is made of porous material.

2. A material had to be found that does not impair the polymerization of the gel solution.

3. The material must exhibit a pore width that allows the proteins to move without obstruction through the wall. After crossing, the proteins in the SDS gel must form the same round, unsmeared ‘spots’, as is the case with the conventional ‘naked’ gels. This was in no way to be expected since experience has shown so far that even minute obstructions in the gel (tiny air bubbles or gel clots) lead to spot smearing.

4. The porous tubes must be enclosed tightly with a plastic film to prevent the gels from drying out during storage (as commercial product) and also to prevent a buffer contact during the IEF run.

5. The film must continue the ‘tube’ upward for applying the sample.

6. The film must be easy to remove after the focusing run to allow the porous tube to be placed onto the SDS gel without the casing and allow the proteins to migrate through it.

The new type of tube represents an essential feature of the invention, which becomes meaningful in the large gel technology only based on the invented concept—high resolution through long, thin capillary tubes.

The invention will be explained in more detail based on the exemplary embodiments, without limiting it to these examples.

### EXAMPLES OF EXECUTION

The separation of proteins in the first dimension is conducted in protein-permeable materials—porous tubes, e.g. in a capillary tube or a capillary hose—and the capillary tube/capillary hose is inserted into a glass case containing a flat gel for further separation of the proteins. Exposed to electric current, the proteins then migrate through the wall of the tube into the flat gel.

The protein-permeable materials consist of plastic [12, 13, 14, 15, 16] or ceramic capillary tubes [9, 10, 12], plastic braided tubes [12, 15] or of polymer membranes in the form of hollow fibers made of polyesters (polycarbonates, polyalkylene terephthalates), poly-sulphones (polyether sulphones, polyarylether sulphones, polyaryl sulphones), polyamides, polyurethanes, polyacrylnitrile, polypropylene, PVDF (polyvinylidene fluoride) or polyether ketones, of natural fibers (such as silk or cotton) or inorganic fibers (apart from ceramic fibers—see above—also glass and other oxide fibers) as well as non-oxide fibers.

Among plastic fibers, polyalkylene terephthalates have proven very useful, particularly polyethylene terephthalate—apart from polybutylene terephthalate or poly(1,4-cyclohexane dimethylene)terephthalate.

In the following examples the test sample used was a protein mixture made of familiar proteins, which we produced ourselves. This test sample contained seven proteins with various molecular weights and isoelectric points.

### Example 1

### Separation of the Proteins in the Second Dimension

### Example 1:1

### Plastic Tubes

A polyester braided tube [12, 14, 15]—50 fibers with 0.1 mm diameter—was filled with a gel solution and used for the 2D electrophoresis.

The 2D gels exhibited the expected seven protein spots. This finding clearly proves that the proteins in the gel tubes of the type “polyester braided tube” [15] could be focused normally and that they entered the 2D gel through the tube wall.

### Example 1:1.1

### Polyethylene Terephthalate

As in example 1:1, while using polyethylene terephthalate [12, 15, 16]

### Example 1:1.2

### Polycarbonate As in example 1:1, while using polycarbonate [13]

### Example 1:1.3

### Polysulphone

As in example 1:1, while using polysulphone [12], however with not such good results as in 1.1.1 and 1.1.2.

### Example 1:2

### Ceramic Capillary Tube [9, 10, 12]

A ceramic capillary tube (Al203) —pore size 0.2 μm, diameter 0.8 mm,—wall thickness 0.18 mm was prepared for a 2D electrophoresis.

In order to test whether these tubes are permeable for proteins, a gel solution was mixed with the test sample. The tubes were filled with this mixture. After polymerization, the tubes were placed on 2D gels. The SDS gel electrophoresis was then conducted in the usual fashion. The result proves that the proteins migrate through the tube without difficulty in the electric field. Upon coloration of the proteins, the sample exhibited seven bands in accordance with the different molecular weights.

### Example 2

### Further Development of the Gel Tubes

Gel tubes with different pore widths are produced in order to be able to separate, depending on the selected pore width, different molecular weight categories from the cell extract. The gel concentration of the 2D gel is adjusted accordingly. This way the highly complex and closely packed protein samples of tissue extracts can be fractioned into several clear samples.

Advantages:

(a) Clear samples simplify the automatic evaluation of the samples.

(b) The samples facilitate the automatic cut-out of the spots for mass spectrometry.

(c) It enables a higher resolution of the overall extract.

(d) A greater purity of the spots for the mass spectrometry (due to fewer spot overlaps) is achieved.

### Example 3

### Drying of the Gels

Drying of the gels in the tubes occurs through air-drying. This is possible even with the gel tubes designed because they are porous.

Drying is of great benefit for the storage and distribution of the gels in gel tubes. Before use, the gels in the gel solution are allowed to reswell.

### Example 4

### Tube Array

The gel tubes are sealed in plastic and hereby bundled—preferably in sets of 10 (tube array FIGS. 3 and 4).

The plastic casing serves the following purposes:

(a) stabilization of the tubes (particularly the tube hoses)

(b) protection of the gels from drying out

(c) for the individual tubes the plastic casing simultaneously represents the neck for application of the sample

(d) in the middle section or on the upper end of the gel tubes, the plastic sleeve forms a platform, with which the entire tube array is clamped into the 1D chamber (FIG. 5)

(e) the plastic casing consists of two parts, which after the 1D run are torn apart to remove the gel tubes (the plastic casing is discarded).

### Example 5

### Special 1D Chamber

A special 1D chamber is designed such that the tube array is clamped therein with a simple manual move (FIG. 5). Clamping ensures that it is sealed completely from the buffer solution in the 1D chamber since the gel tubes must migrate through the bottom of the 1D chamber.

### Example 6

### Pipetting Robot

A pipetting robot, which has been designed specifically for the purpose of this invention, is in a position to fill the capillary tubes with fluid (FIG. 4).

It fulfills the following functions:

(a) fill capillaries with a diameter of about 1 mm and a depth of about 3.5 cm with a slightly viscous solution without creating air bubbles

(b) portion the solutions accurately in the μl range

(c) layer three liquids with different density values

(d) fill 10 tubes successively

(e) change the pipetting head when applying different samples so as to avoid contamination from the entrainment of the samples

The samples are applied when the tube array has already been placed into the chamber.

### Example 7

### 2D Gels as Finished Gels

The 2D gels are also offered as finished gels to interested parties/consumers. They are supplied ready-to-use in a plastic case (FIG. 6). The plastic case has the following characteristics:

a) It is transparent.

b) It ends in a platform, with which it can be clamped easily into the 2D chamber (see above example 4(d)).

c) After the run, the case can be torn open and then releases the gel (the used case is discarded; the particularly cumbersome cleaning of the plates is eliminated).

d) On the bottom—0.5 cm above the end—the case contains a simple marking, which aids in detecting the end of the run.

### Example 8

### 2D Chamber

A 2D chamber is designed such that optionally up to 10 gel cases can be hung in it (FIG. 7). It is sealed with the help of the case platform (see above Example 7 (b)).

### Example 9

### IPG gels in Tubes

Equivalent to Examples 2 and 4, IPG gels are produced in tubes.

### Example 10

### HTP-2DE Apparatus

In the last completion stage of the HTP-2DE apparatus (high throughput technique) only the following manual moves are required: clamp the tube array into the 1D chamber, clamp the 2D gels into the 2D chamber, place the tube gels on the 2D gels, add buffer for the 1D and 2D chambers. Filling, emptying and cleaning of the chambers is automated to such an extent that only the supply vessels filled with the buffer.

Legend for Figures
FIGS. 1 through 8 show:

standard 2D electrophoresis
improvement in the 1D gel technique
gel tube, longitudinal view
gel tube, cross-section
tube array and pipetting robot
tube array and 1D buffer chamber (section)
2D case
2D cases in the buffer chamber

Reference Number List for Figures

| | |
|---|---|
| 1 | protein sample |
| 2 | IEF gel |
| 3 | glass tube |
| 4 | isoelectric focusing |
| 5 | SDS gel electrophoresis |
| 6 | IEF gel on the SDS gel |
| 7 | gel case |
| 8 | protein spots |
| 9 | protein sample |
| 10 | plastic casing |
| 11 | porous gel tube |
| 12 | porous gel tube with gel on the SDS gel |
| 13 | plastic casing encloses the tube and connects several tubes |
| 14 | porous capillary tube |
| 15 | like 13/14, but cross-sectional view |
| 16 | pipetting robot |
| 17 | tube array: capillary tubes, encased and connected by a |
| | double-layer plastic film; after tearing the two layers apart, |
| | the tubes can be removed; a transverse reinforcement |
| | (platform) serves to fasten the tube arrays in the focusing |
| | chamber |
| 18 | fastening of the tube array in the focusing chamber |
| | (clamping device) |
| 19 | the platform mentioned in 17 shown in a top view |
| 20 | 2D case in cross-sectional view: contains the SDS gel |
| | and the IEF gel |
| 21 | 2D case in the side view |
| 22 | 2D cases in the buffer chamber |

List of Abbreviations

| | |
|---|---|
| [1] through | bibliographical reference 1 |
| [16] | bibliographical reference 16 |
| AGT | A/G Technology Corporation, USA |
| 1D | one-dimensional |
| 1D gels | 1-dimensional gels |
| 2D | two-dimensional |
| 2DE/2-DE | two-dimensional electrophoresis |
| CA | carrier ampholyte |
| CA-2DE | CA-2-dimensional electrophoresis |
| HTP-2DE | high throughput technique |
| IEF gels | isoelectric focusing gels |
| IPG | immobilized pH gradients, Immobiline ® |
| IPG-2DE | IPG-2-dimensional electrophoresis |
| kDa | kilo Dalton (measure for molecular weight) |
| PAGE | polyacrylamide gel electrophoresis |
| PVDF | polyvinylidene fluoride |
| SDS- | sodium dodecyl sulfate |

Bibliography

[1] Klose J. (1975) Humangenetik (Human Genetics) 26: 231-243

[2] O'Farrell, P. H. (1975), J. Biol. Chem. 250, 4007-4021

[3] Gasparic, V., Bjlellquist, B., Rosengren, A. (1975) Swedish patent 14049-1

[4] Bjlellquist, B., Ek K. (1982) LKB Application Note 321

[5] Bjlellquist et al. (1982) J. Biochem. Biophys. Methods 6, 317-339

[6] Klose J., Kobalz U. (1995) Electrophoresis 16: 1034-1059

[7] Klose J., (1999) Methods in Molecular Biology 112: 147-172

[8] Klose J., (1999) Methods in Molecular Biology 112: 67-86

[9] Tudyka S., K. Pflanz, N. Stroh, H. Brunner, F. Aldinger (1998): Herstellung und Eigenschaften von Keramikmembranen für die Flüissigfiltration (Production and Characteristics of Ceramic Membrane for Fluid Filtration), Keram. Z. 50 (10): 818-826

[10] Stroh N., D. Sporn: Keramische Hohlfasern—Eine neue Geometrie in der Separationstechnik (Hollow Ceramic Fibers—A new geometry in Separation Technology), DECHEMA Annual Conference on Membrane Technology 1999, Apr. 27-29, 1999, Wiesbaden, Germany

[11] Catalog Reichelt Chemietechnik 2000, Reichelt Chemietechnik company

[12] Fraunhofer Institute, Grenzflaechen—und Bioverfahrenstechnik (Boundary and Bio-Method Technology), Nobelstr. 12, D-70569 Stuttgart, Germany, tel.: +49-711 970 4120, Fax: +49-711 970

[13] Lück, H. B., et al, Nuclear Instruments and Methods in Physics Research B50, 1990, 395-400

[14] Akzo Faser AG, Öhder Str. 28, D-42289 Wuppertal, Germany Fresenius GmbH, Frankfurter Str. 6-8, D-66606 St. Wendel, Germany Gambro Dialysatoren GmbH & Co KG, Holger-Crafoord-Strasse 26, D-72372 Hechingen, Germany

[15] Erfurter Flechttechnik GmbH, Stauffenbergallee 13, D-99086 Erfurt, Germany

[16]—X-Flow B.V., Bedrijvenpark Twente 289, NL-7602 KK Almelc, Netherlands—AGT-AIG Technology Corporation, 101 Hampton Avenue, Needham, Mass. 02194-2628, USA.

1. Method for separating complex protein mixtures with the help of two-dimensional electrophoresis (2D electrophoresis, 2DE), characterized in that the separation of the proteins in the first dimension takes place in hollow porous protein-permeable materials and that in the second dimension the porous materials are introduced in an unmodified state into a glass case containing a flat gel, into which the proteins migrate through the wall of the porous material during the electrophoresis.

2. Method pursuant to claim 1, characterized in that as the hollow porous protein-permeable materials, which are filled with a ready-to-use gel and are available in the form of gel tubes,
2.1 plastic tubes or plastic hoses
2.2 ceramic tubes are used.

3. Method pursuant to the claims 1 and 2, characterized in that as plastic materials
3.1 polyesters in the form of
3.1.1 polyalkylene terephthalates
3.1.2 polycarbonates or
3.2 polysulphones or
3.3 polyamides, polyurethanes, polyacrylnitrile, polypropylene, polyvinyliden fluorides or polyether ketones
are used and that as the hollow porous protein-permeable materials polyester braided tubes made of polyethylene terephthalate are used.

4. Method pursuant to the claims 1 through 3, characterized in that the gel tubes have pore sizes from 0.2 to 0.005 μm for proteins smaller than 400 to smaller than 10 kDa.

5. Method pursuant to the claims 1 through 4, characterized in that the gels are dried in the tubes, are offered in this form to the consumer and are reswollen in a gel solution before use.

6. Method pursuant to the claims 1 through 5, characterized in that the gel tubes are sealed in plastic and are bundled into tube arrays, wherein the plastic casing forms a platform with which the entire tube array is clamped into the 1D chamber and the plastic casting consists of two parts, which are separated after the 1D run to remove the gel tubes.

7. Method pursuant to the claims 1 through 6, characterized in that the tube array is clamped into a special 1D chamber by means of a clamping device (FIG. 6).

8. Method pursuant to the claims 1 through 7, characterized in that the capillary tubes are filled with fluid by a pipetting robot.

9. Method pursuant to the claims 1 through 8, characterized in that the 2D gels are used as finished gels, which are supplied ready-to-use in a plastic case.

10. Method pursuant to the claims 1 through 9, characterized in that the gels are placed in tubes as IPG gels.

11. Method pursuant to the claims 1 through 10, characterized in that when employing the high throughput technique (HTP-2DE) the tube arrays are clamped into the 1D chamber and the 2D gels into the 2D chamber, the tube gels are placed on the 2D gels and buffer solutions are used for the 1D and 2D chambers.

12. Device for separating complex protein mixtures with the help of the 2D electrophoresis (2DE), consisting—apart from standard elements used in 1D as well as 2D technology—of hollow porous protein-permeable materials for the 1D step and a glass case containing a flat gel for receiving after the 1D step the unmodified hollow porous protein-permeable materials for the 2-DE step.

13. Device pursuant to claim 12, characterized in that the hollow porous protein-permeable materials consist of porous tubes, capillary tubes or capillary hoses.

14. Device pursuant to claims 12 through 13, characterized in that the porous materials consist of
14.1 plastic tubes or plastic hoses or
14.2 ceramic tubes,
which are filled with a ready-to-use gel and are available as gel tubes.

15. Device pursuant to claims 12 through 14, characterized in that the porous plastic materials consist of
15.1 polyester in the form of
15.1.1 polyalkylene terephthalates
15.1.2 polycarbonates or
15.2 polysulphones or
15.3 polyamides, polyurethane, polyacrylnitriles, polypropylene, polyvinylidene fluorides or polyether ketones and the hollow porous protein-permeable materials consist of polyester braided tubes in the form of polyethylene terephthalate.

16. Device pursuant to claims 12 through 15, characterized in that the gel tubes have pore sizes from 0.2 to 0.005 μm for proteins smaller than 400 to smaller than 10 kDa.

17. Device pursuant to claims 12 through 16, consisting furthermore of gel tubes (FIG. 3, FIG. 4) as well as of gel tubes bundled into tube arrays (17, FIG. 5, FIG. 6), of a tube array and pipetting robot (16), tube array and buffer chamber (22, FIG. 8), 2 D cases (20, 21), 2D cases in the buffer chamber, a special 1D chamber (FIG. 6), 2D gels as finished gels (20, 21), a 2D chamber (FIG. 8) as well as an HTP-2DE apparatus.

18. Device pursuant to claims 12 through 17, consisting furthermore of IPG gels in tubes.

19. Use of the method and the device pursuant to claims 1 through 18 for separating complex protein mixtures.

20. Use pursuant to claim 19 in large gel technology.

21. Use pursuant to claims 19 and 20, characterized in that the hollow porous materials are used in the form of hollow plastic fibers, plastic braided tubes or ceramic capillary tubes/hollow ceramic fibers in the 1D electrophoresis and after that in an unmodified state in the 2D electrophoresis.
